(19) United States
(12) Patent Application Publication
(10) Pub. No.: US 2008/0025431 A1
(43) Pub. Date: Jan. 31, 2008

(54) TRANSMITTING APPARATUS AND METHOD, RECEIVING APPARATUS AND METHOD

(75) Inventors: Seiichiro Horikawa, Kawasaki-shi (JP); Hideo Kasami, Yokohama-shi (JP); Hiroshi Yoshida, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/689,092

(22) Filed: Mar. 21, 2007

(30) Foreign Application Priority Data
Jul. 28, 2006 (JP) 2006-206785

(51) Int. Cl. H04L 27/00

(52) U.S. Cl. 375/295

(57) ABSTRACT

A transmitting apparatus converts a unit data item of the unit data items having a predetermined bit length into a time shift amount, stores, in a memory, a first symbol including a plurality of samples, generates a second symbol corresponding to the unit data item by cyclically shifting the samples in the first symbol by the time shift amount, and transmits the second symbol. A receiving apparatus receives two consecutive symbols each including a plurality of samples, detects sample values of the samples in each of the symbols, detects a time shift amount between the symbols based on the sample values of the samples in each of the symbols, and converts the time shift amount into a data item having the bit length.

### CROSS-REFERENCE TO RELATED APPLICATIONS

This application is based upon and claims the benefit of priority from prior Japanese Patent Application No. 2006-206785, filed Jul. 28, 2006, the entire contents of which are incorporated herein by reference.

### BACKGROUND OF THE INVENTION

1. Field of the Invention

The present invention relates to a wireless communication apparatus.

2. Description of the Related Art

An IF detection scheme of performing demodulation using only a phase is available as a technique of simplifying the arrangement of a receiving apparatus [see, for example, JP-A 11-98208 (KOKAI)].

The above technique, however, has a problem that since it performs demodulation using only a phase, if the transmission speed increases, the reception characteristics greatly deteriorate due to interference from a delayed wave under a multipath delay environment.

### BRIEF SUMMARY OF THE INVENTION

According to embodiments of the present invention; a transmitting apparatus (a) converts a unit data item of the unit data items having a predetermined bit length into a time shift amount, (b) stores, in a memory, a first symbol including a plurality of samples, (c) generates a second symbol corresponding to the unit data item by cyclically shifting the samples in the first symbol by the time shift amount, and (d) transmits the second symbol; a receiving apparatus (e) receives two consecutive symbols each including a plurality of samples, (f) detects sample values of the samples in each of the symbols, (g) detects a time shift amount between the symbols based on the sample values of the samples in each of the symbols, and (h) converts the time shift amount into a data item having the bit length.

### BRIEF DESCRIPTION OF THE SEVERAL VIEWS OF THE DRAWING

FIG. 1 is a block diagram showing an example of the arrangement of a transmitting apparatus according to the first embodiment;

FIG. 2 is a view for explaining the principle of symbol generation processing;

FIG. 3 is a block diagram showing an example of the arrangement of a receiving apparatus according to the second embodiment;

FIG. 4 is a block diagram showing an example of the arrangement of a phase detector in FIG. 3;

FIG. 5 is a block diagram showing the arrangement of the phase detector in FIG. 4 in more detail;

FIG. 6 is timing chart for explaining the operation of the phase detector in FIG. 5;

FIG. 7 is a block diagram showing another example of the arrangement of the phase detector;

FIG. 8 is a block diagram showing a further example of the arrangement of the phase detector;

FIG. 9 is timing chart for explaining the operation of the phase detector in FIG. 8;

FIG. 10 is timing chart for explaining the operation of the phase detector in FIG. 8;

FIG. 11 is timing chart for explaining the operation of the phase detector in FIG. 8;

FIG. 12 is timing chart for explaining the operation of the phase detector in FIG. 8;

FIG. 13 is a block diagram showing an example of the arrangement of a time shift amount detector in FIG. 3;

FIG. 14 is a block diagram showing an example of the arrangement of a transmitting apparatus according to the second embodiment;

FIG. 15 is a block diagram showing an example of the arrangement of a receiving apparatus according to the second embodiment;

FIG. 16 is a block diagram showing an example of the arrangement of a time shift amount and sign detector in FIG. 15;

FIG. 17 is a block diagram showing an example of the arrangement of a transmitting apparatus according to the third embodiment;

FIG. 18 is a block diagram showing an example of the arrangement of a receiving apparatus according to the third embodiment;

FIG. 19 is a block diagram showing an example of the arrangement of a time shift amount and phase detector in FIG. 18;

FIG. 20 is a block diagram showing an example of the arrangement of a receiving apparatus according to the fourth embodiment;

FIG. 21 is a block diagram showing an example of the arrangement of a time shift amount detector in FIG. 20;

FIG. 22 is a graph showing a straight line representing the phase characteristic of each sample (K=0, 1, . . . , N−1) in a symbol in a frequency domain;

FIG. 23 is a block diagram showing an example of the arrangement of a receiving apparatus according to the fifth embodiment;

FIG. 24 is a block diagram showing an example of the arrangement of a time shift amount and phase detector in FIG. 23;

FIG. 25 is a graph showing another example of a straight line representing the phase characteristic of each sample (K=0, 1, . . . , N−1) in a symbol in a frequency domain;

FIG. 26 is a block diagram showing an example of the arrangement of a receiving apparatus according to the sixth embodiment;

FIG. 27 is a block diagram showing an example of the arrangement of a phase detector in FIG. 26;

FIG. 28 is timing chart for explaining the operation of the phase detector in FIG. 27;

FIG. 29 is a view showing an example of a conversion table for converting 2-bit data into a time shift amount;

FIG. 30 is a view showing an example of a conversion table for converting a time shift amount into 2-bit data;

FIG. 31 is a view showing an example of a conversion table for converting 1-bit data into a sign;

FIG. 32 is a view showing an example of a conversion table for converting a sign into 1-bit data;

FIG. 33 is a view showing an example of a conversion table for converting 2-bit data into a phase; and

FIG. 34 is a view showing an example of a conversion table for converting a phase into 2-bit data.

### DETAILED DESCRIPTION OF THE INVENTION

The embodiments of the present invention will be described below with reference to the views of the accompanying drawing.

The same reference numerals denote the same parts in the following description.

### First Embodiment

A transmitting apparatus according to the first embodiment will be described.

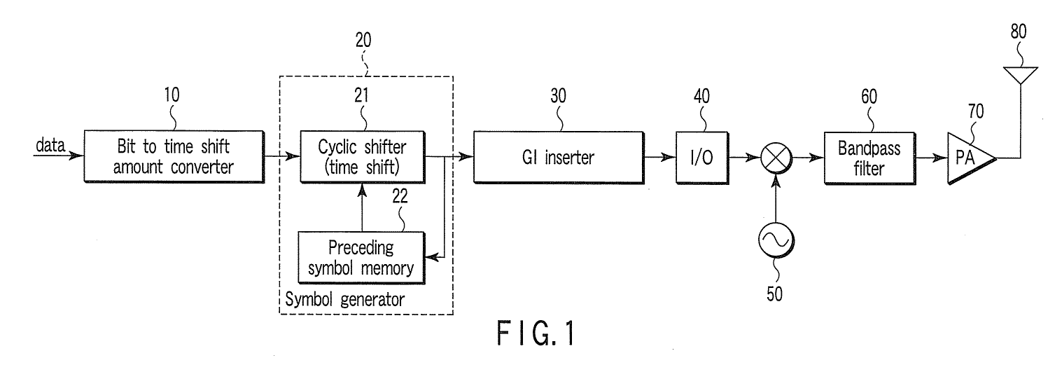

The arrangement and operation of the transmitting apparatus according to the first embodiment will be described below with reference to FIG. 1.

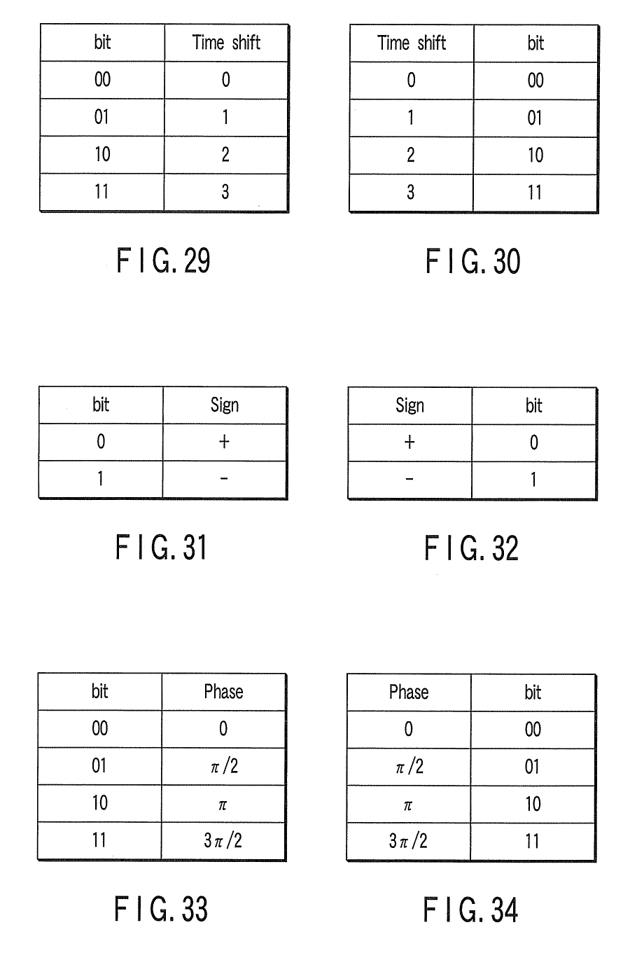

A bit to time shift amount converter 10 delimits input data for each predetermined number of bits, and converts each unit data into a time shift amount. The bit to time shift amount converter 10 converts each unit data into a time shift amount by using, for example, a conversion table like that shown in FIG. 29.

Assume that as shown in FIG. 29, the number of bits of unit data is two. In this case, when unit data is “00”, the time shift amount is “0”. When unit data is “01”, the time shift amount is “1”. When unit data is “10”, the time shift amount is “2”. When unit data is “11”, the time shift amount is “3”.

A symbol generator 20 converts the time shift amount converted by the bit to time shift amount converter 10 into a symbol. The symbol generator 20 will be described below.

The symbol generator 20 includes a preceding symbol memory 22 and a cyclic shifter 21, and generates a symbol including a plurality of samples each having a predetermined initial value. The plurality of samples in the symbol include at least one index sample which differs in value or sign from the remaining samples.

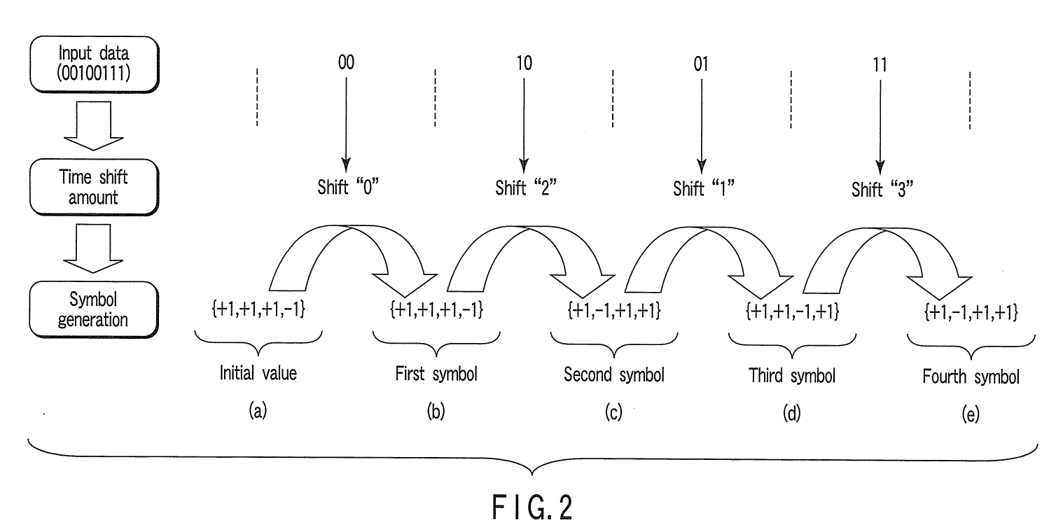

Symbol generation processing performed by the symbol generator 20 will be described with reference to FIG. 2.

Referring to FIG. 2, one symbol includes four samples having initial values {+1, +1, +1, −1}. In this case, a sample with the value “−1” is an index sample.

Assume that the bit to time shift amount converter 10 delimits input data for each two bits, and unit data comprises two bits.

The preceding symbol memory 22 of the symbol generator 20 temporarily stores the immediately preceding symbol generated by the symbol generator 20. Note that in an initial state, the preceding symbol memory 22 stores the default symbol {+1, +1, +1, −1}.

The cyclic shifter 21 of the symbol generator 20 generates a symbol corresponding to each unit data by cyclically shifting the samples in the symbol stored in the preceding symbol memory 22 (which is generated from the immediately preceding unit data) by a time shift amount (sample time, which is obtained by the bit to time shift amount converter 10) corresponding to the unit data.

Assume that the preceding symbol memory 22 stores the default symbol {+1, +1, +1, −1}, as indicated by “(a)” in FIG. 2.

If unit data are “00”, “10”, “01”, and “11”, the symbol generator 20 generates symbols corresponding to the respective unit data in the order named.

First of all, as indicated by “(a)” in FIG. 2, the cyclic shifter 21 cyclically shifts the symbol {+1, +1, +1, −1} stored in the preceding symbol memory 22 by the time shift amount “0” corresponding to the unit data “00”, and outputs the first symbol {+1, +1, +1, −1} corresponding to the unit data “00”. As indicated by “(b)” in FIG. 2, the preceding symbol memory 22 stores this symbol as a new preceding symbol.

As indicated by “(b)” in FIG. 2, the cyclic shifter 21 cyclically shifts the symbol {+1, +1, +1, −1} stored in the preceding symbol memory 22 by the time shift amount “2” corresponding to the unit data “10”, and outputs the second symbol {+1, −1, +1, +1} corresponding to the unit data “10”. As indicated by “(c)” in FIG. 2, the preceding symbol memory 22 stores this symbol as a new preceding symbol.

As indicated by “(c)” in FIG. 2, the cyclic shifter 21 cyclically shifts the symbol {+1, −1, +1, +1} stored in the preceding symbol memory 22 by the time shift amount “1” corresponding to the unit data “01”, and outputs the third symbol {+1, +1, −1, +1} corresponding to the unit data “01”. As indicated by “(d)” in FIG. 2, the preceding symbol memory 22 stores this symbol as a new preceding symbol.

As indicated by “(d)” in FIG. 2, the cyclic shifter 21 cyclically shifts the symbol {+1, +1, −1, +1} stored in the preceding symbol memory 22 by the time shift amount “3” corresponding to the unit data “11”, and outputs the fourth symbol {+1, −1, +1, +1} corresponding to the unit data “11”. As indicated by “(e)” in FIG. 2, the preceding symbol memory 22 stores this symbol as a new preceding symbol.

The symbol generated by the symbol generator 20 is stored in the preceding symbol memory 22 and is also output to a guard interval (GI) inserter 30. The GI inserter 30 inserts part of the tail of the input symbol, as a guard interval, into the head of the symbol.

An IO converter 40 converts the symbol in which the guard interval is inserted by the GI inserter 30 from a digital signal to an analog signal. A frequency converter 50 then converts the analog signal into an RF signal (although this embodiment uses the IO converter, it may use a DA converter).

A bandpass filter 60 band-limits the RF signal converted by the frequency converter 50. An amplifier 70 then amplifies this signal and transmits the amplified signal from an antenna 80 into the atmosphere.

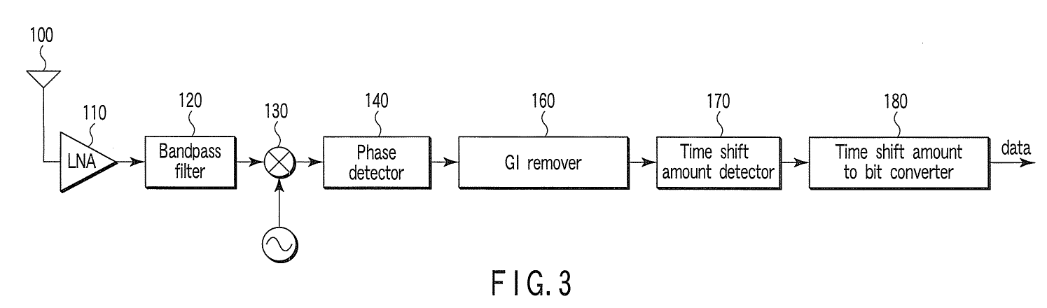

The arrangement and operation of the receiving apparatus according to the first embodiment will be described below with reference to FIG. 3.

An LNA 110 amplifies the RF signal received by an antenna 100. A bandpass filter 120 then band-limits this signal.

A frequency converter 130 converts the signal band-limited by the bandpass filter 120 into an IF signal and inputs it to a phase detector 140. The phase detector 140 detects the phase of the input signal.

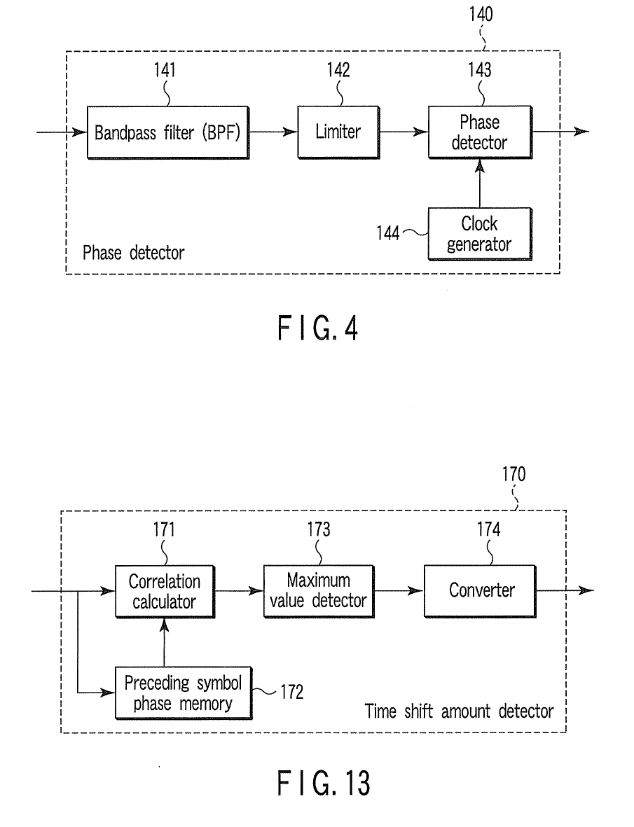

FIG. 4 shows an example of the arrangement of the phase detector 140. The phase detector 140 detects the relative phase difference between an input signal and a clock signal by using a clock generator 144 which generates a clock signal. First of all, a bandpass filter 141 band-limits the IF signal (input signal) input from the frequency converter 130 to the phase detector 140. A limiter 142 converts the IF signal band-limited by the bandpass filter 141 into a rectangular wave. A phase detector 143 detects the relative phase difference between the rectangular wave obtained by the limiter 142 and the clock signal generated by the clock generator 144.

FIG. 5 shows an example of the arrangement of the phase detector 140, with the arrangement of the phase detector 143 being shown in more detail.

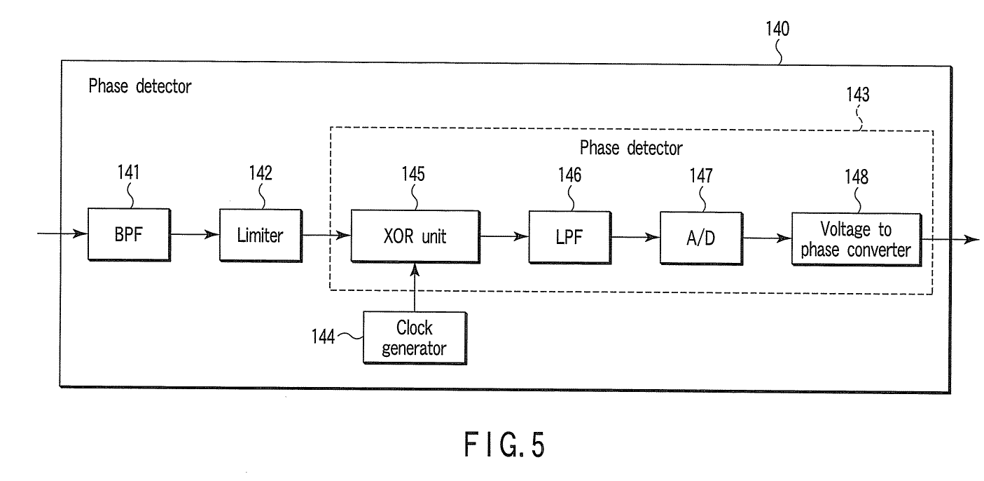

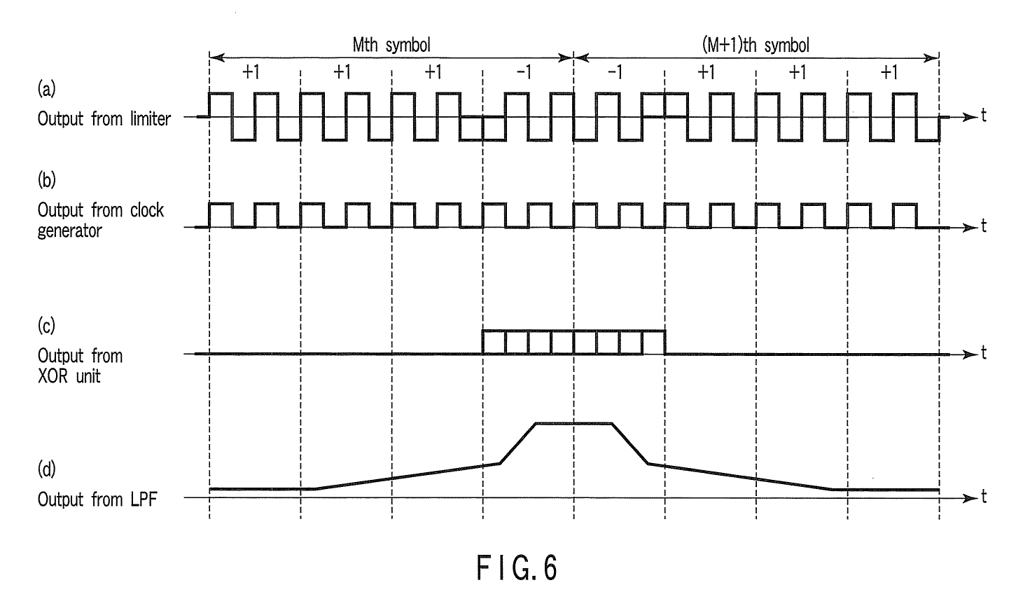

FIG. 6 shows a case wherein the phases of two consecutive symbols, i.e., the Mth symbol and the (M+1)th symbol, are detected. The (M+1)th symbol is obtained by cyclically shifting the Mth symbol by the sample time “1”.

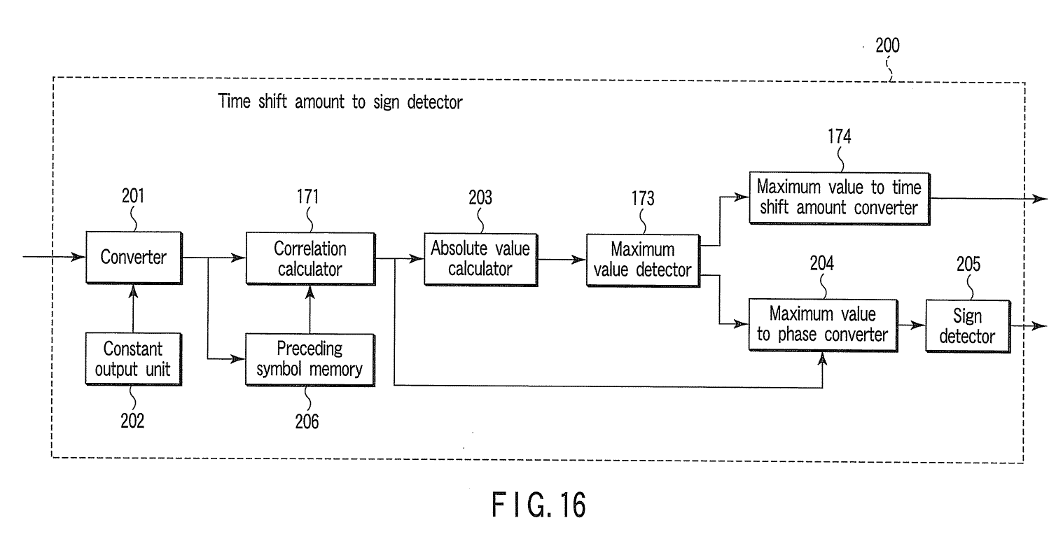

As shown in FIG. 5, an exclusive OR (XOR) unit 145 receives the rectangular wave (FIG. 6(a)) output from the limiter 142 and the clock signal (FIG. 16(b)) output from the clock generator 144. The XOR unit 145 obtains the exclusive OR of the rectangular wave signal shown in FIG. 6(a) and the clock signal shown in FIG. 6(b), and outputs the resultant signal (FIG. 6(c)) to a low-pass filter (LPF) 146.

The LPF 146 outputs, to an AD converter 147, a signal like that shown in FIG. 6(d) which indicates the relative phase difference between the rectangular wave signal of each sample in each symbol in FIG. 6(a) and the clock signal in FIG. 6(b). The AD converter 147 converts the signal from an analog signal to a digital signal, and inputs the signal to a voltage to phase converter 148. The voltage to phase converter 148 converts the voltage value of the input signal into the phase of each sample in each symbol (the phase difference from the clock signal in FIG. 6(b)) which corresponds to the voltage value.

As shown in FIG. 6, although the relative phase difference between a clock signal corresponding to the sample with the value “+1” in the Mth symbol and that in the (M+1)th symbol is almost “0”, the relative phase difference from the clock signal corresponding to the index sample is almost “π”. Therefore, obtaining the exclusive OR of the rectangular wave shown in FIG. 6(a) and the clock signal shown in FIG. 6(b) by using the XOR unit 145 makes it possible to detect the time position of the index sample at which the phase difference is almost “π” from the phase difference between the clock signals corresponding to the respective samples in the respective symbols, as shown in FIG. 6(c).

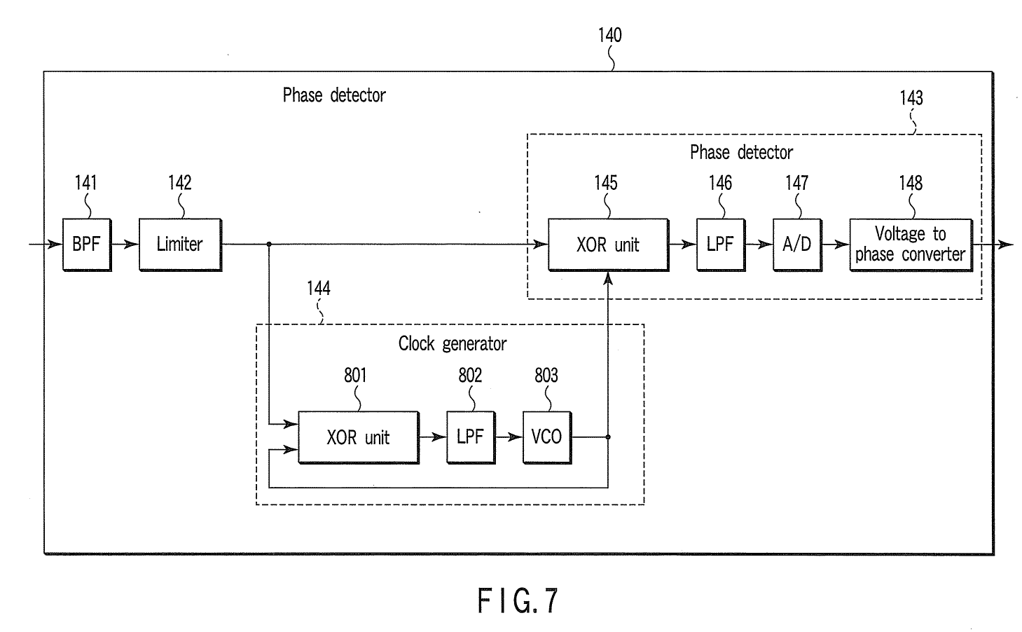

As a method of improving phase detection accuracy, there is available a method of synchronizing the frequency and phase of the rectangular wave signal output from the limiter 142 with those of the clock signal generated by the clock generator 144. FIG. 7 shows another example of the arrangement of the phase detector 140, with the arrangement of the clock generator 144 being shown in more detail.

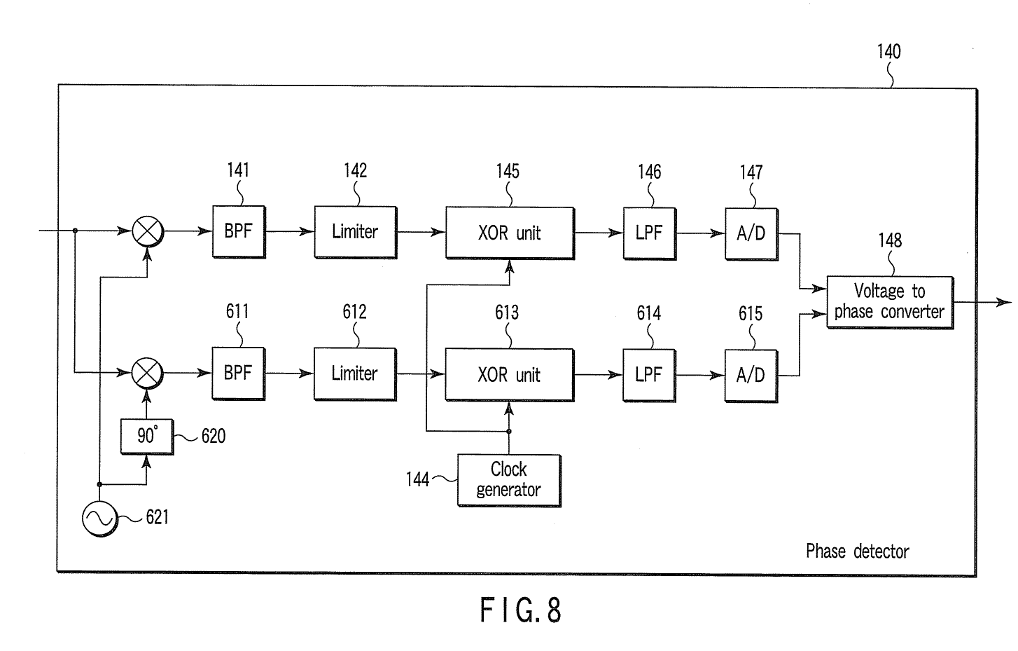

The arrangement shown in FIG. 7 is identical to that of a general PLL, in which the clock signal output from a VCO 803 is input to an XOR unit 801, and control is performed to synchronize the frequency and phase of the rectangular wave output from the limiter 142 with those of the clock signal generated by the VCO 803. An output signal from the XOR unit 801 is input to a low-pass filter (LPF) 802 which extracts only the frequency and phase of a carrier. The signal from which a high-frequency component is removed by the LPF 802 is input to the VCO 803 to control the frequency and phase of the VCO 803. FIG. 8 shows a further example of the arrangement of the phase detector 140. The phase detector 140 shown in FIG. 8 receives two IF signals having a phase difference of 90° as input signals. In this case, of the two IF signals output from the frequency converter 130, a system without a phase shift is called an I-channel (I-cH), and a system with a phase shift of 90° is called a Q-channel (Q-cH).

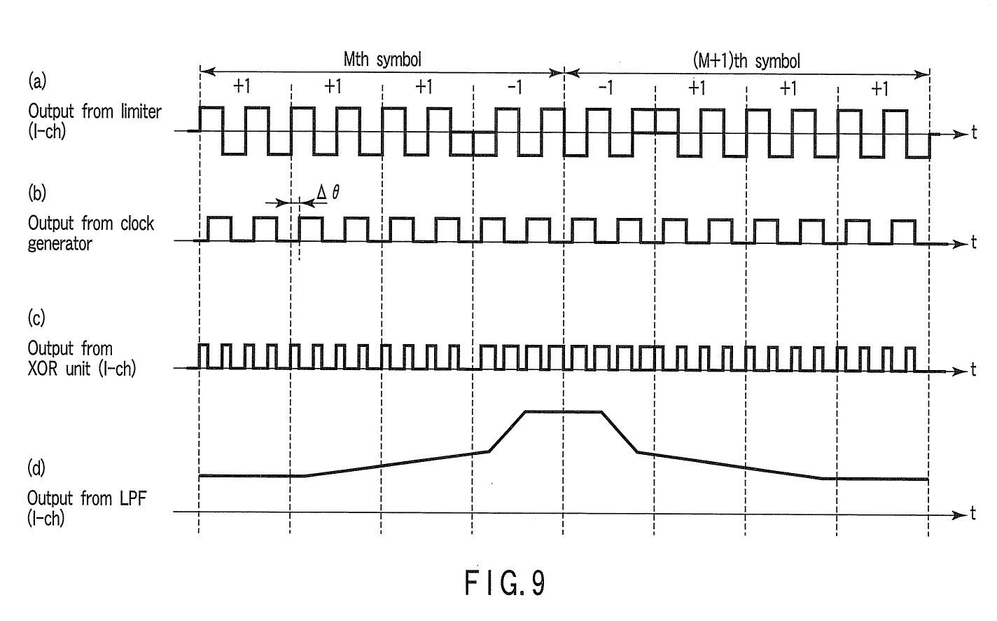

FIGS. 9 to 12 are timing charts for explaining the operation of the phase detector 140 in FIG. 8.

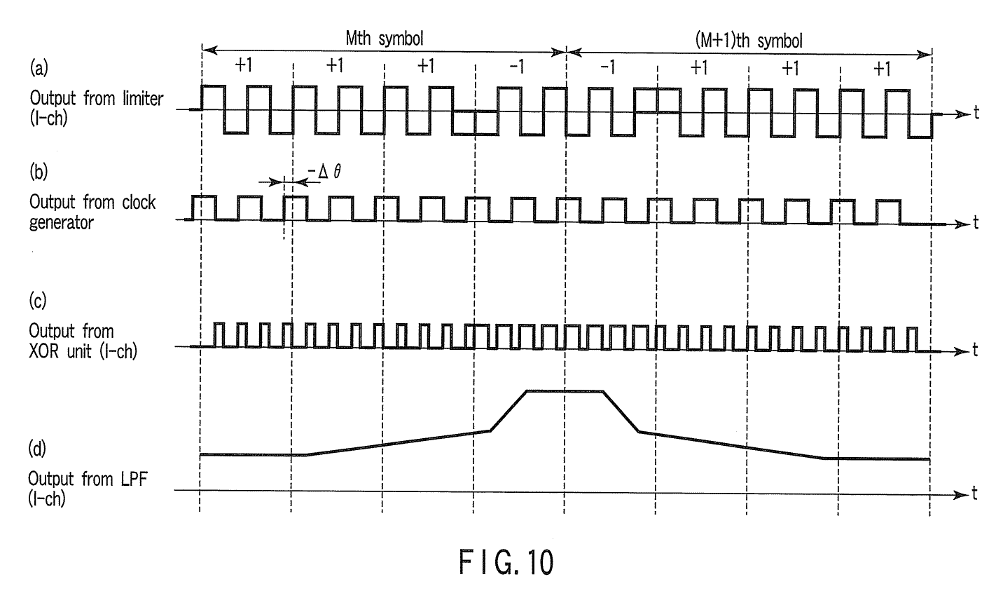

Assume that a given IF signal has the same absolute value of a relative phase difference from a clock signal and differs in sign. In this case, as shown in FIGS. 9 and 10, if this signal is from only one system (I-cH), both when the phase of the IF signal differs from that of the clock signal by Δθ and by −Δθ, the low-pass filter (LPF) outputs the same result through the XOR unit, and the sign of the phase difference between the IF signal and the clock signal cannot be detected.

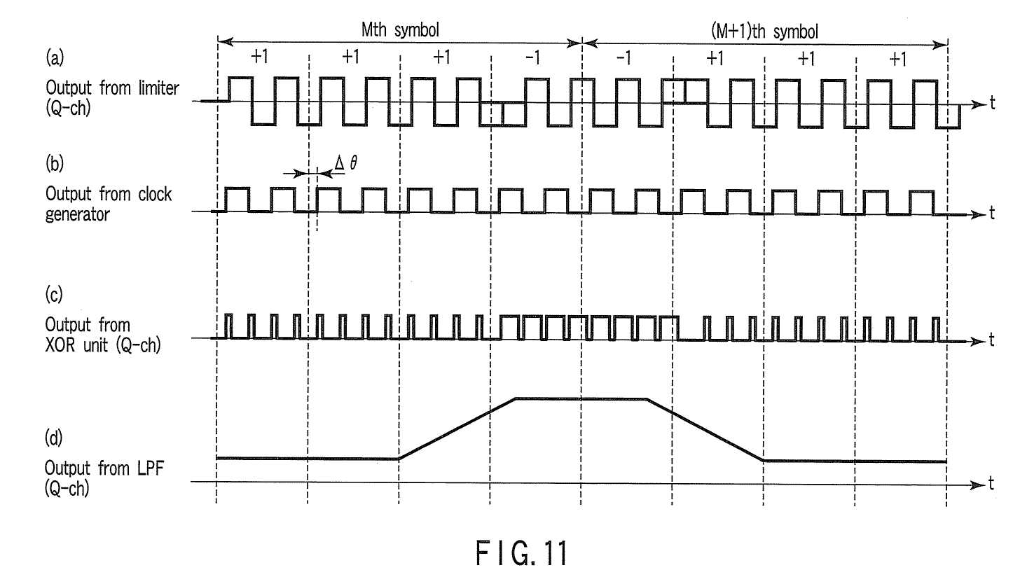

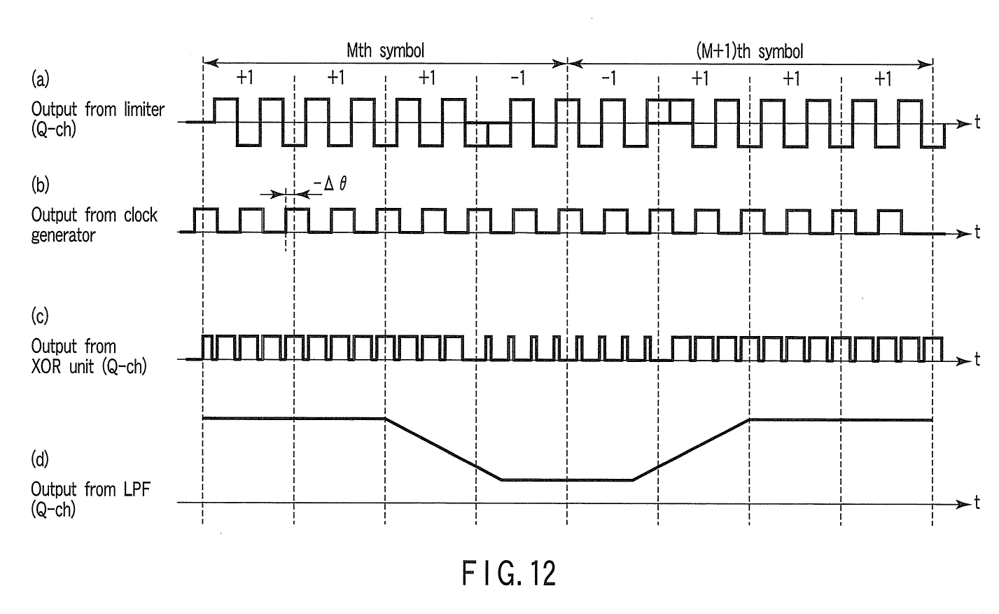

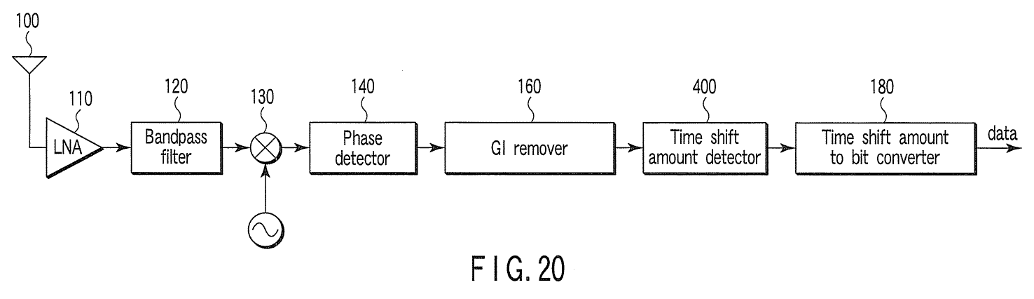

In contrast, when the phase of the IF signal differs from that of the clock signal by Δθ, using the I-cH IF signal in FIG. 9 and the Q-cH IF signal in FIG. 11 which has a phase difference of 90° from the I-cH IF signal makes it possible to detect the sign “+” of the phase difference between the IF signal and the clock signal. When the phase of the IF signal differs from that of the clock signal by −Δθ, using the I-cH IF signal in FIG. 20 and the Q-cH IF signal in FIG. 12 which has a phase difference of 90° from the I-cH IF signal makes it possible to detect the sign “−” of the phase difference between the IF signal and the clock signal.

The voltage to phase converter 148, which receives the signal output from the AD converter 147 of the I-cH and the signal from an AD converter 615 of the Q-cH, converts the voltage value of the input signal of each system into the phase of each sample in each symbol (the phase difference from the clock signal in FIG. 6(b)) which corresponds to the voltage value.

Using two systems (I-cH and Q-cH) in this manner makes it possible to also detect the sign of the phase difference between an IF signal and a clock signal. That is, this makes it possible to more accurately obtain the phase of each sample in each symbol (a phase difference from a clock signal).

Referring back to FIG. 3, a guard interval (GI) remover 160 removes a guard interval from the phase detected by the phase detector 140. A time shift amount detector 170 then converts the resultant phase into a time shift amount. The time shift amount detector 170 will be described below assuming that time synchronization has been completely established.

FIG. 13 shows an example of the arrangement of the time shift amount detector 170. The time shift amount detector 170 detects, for each pair of two consecutive symbols, a cyclic shift amount (sample time count) from the time position of the index sample of a preceding one of the two symbols to the index sample of the succeeding symbol on the basis of the phase of each sample in each symbol. That is, for each pair of two consecutive symbols, the time shift amount detector 170 obtains the correlation value between the two symbols while cyclically shifting one (e.g., the preceding symbol in this case) of the two symbols by one sample time at a time, and detects a sample time count as a cyclic shift amount until the highest correlation value is obtained. For this purpose, the time shift amount detector 170 includes a preceding symbol phase memory 172 which stores a phase corresponding to each sample of the preceding sample of the two consecutive symbols, a correlation calculator 171, a maximum value detector 173, and a converter 174.

Note that in the following description, the phase of the nth sample of the Mth symbol is represented by

∠xₙ^{(M)}(0≦n≦N−1)

Assume that one symbol contains N samples from n=0 to n=N−1.

The operation of the time shift amount detector 170 for the Mth symbol will be described below.

The correlation calculator 171 receives digital signals (∠x₀^{(M)}, . . . ,∠x_{N-1}^{(M)}) each representing the phase of each sample in the Mth symbol obtained when the GI remover 160 removes a guard interval.

The correlation calculator 171 calculates the correlation value between the phase of each sample in the Mth input symbol and a phase corresponding to each sample in the preceding symbol ((M−1)th symbol) stored in the preceding symbol phase memory 172, which is (∠x₀^{(M-1)}, . . . ,∠x_{N-1}^{(M-1)})

The correlation calculator 171 calculates a correlation value yₙ (y₀, . . . , y_{N-1}) between the (M−1)th symbol stored in the preceding symbol phase memory 172 and the Mth symbol by using the following formula (1), while cyclically shifting the (M−1)th symbol by one sample time at a time (in the same direction as the cyclic shift direction in the cyclic shifter 21 of the transmitting apparatus).

$$\begin{matrix}{y}_{n} = {\sum }_{p = 0}^{N - 1} ∠ {x}_{p}^{( M )} ∠ {x}_{MOD ( p - n + N , N )}^{( M - 1 )} & ( 0 \leq n \leq N - 1 )\end{matrix} \qquad ( 1 )$$

Note that MOD(a,b) is a value obtained by performing modulus operation of b with respect to a.

In this case, let y₀ be the correlation value obtained between the (M−1)th symbol and the Mth symbol without cyclically shifting the (M−1)th symbol, y₁ be the correlation value obtained between the (M−1)th symbol and the Mth symbol when the (M−1)th symbol is cyclically shifted by one sample time, y₂ be the correlation value obtained between the (M−1)th symbol and the Mth symbol when the (M−1)th symbol is cyclically shifted by two sample times, and y_{N-1} be the correlation value obtained between the (M−1)th symbol and the Mth symbol when the (M−1)th symbol is cyclically shifted by (N−1) sample times.

The maximum value detector 173 detects one of a plurality of correlation values (y₀, . . . , y_{N-1}), obtained while performing cyclic shifting by one sample time at a time, which has a highest level. The converter 174 converts a maximum correlation value yₙ (0≦n≦N−1) detected by the maximum value detector 173 into a cyclic shift amount (sample time count) up to the maximum correlation value, i.e., “n sample times”.

Referring back to FIG. 3, a time shift amount to bit converter 180 receives the cyclic shift amount (time shift amount) detected by the time shift amount detector 170. The time shift amount to bit converter 180 converts the input time shift amount, i.e., “n sample times” in this case, into data of a predetermined bit length corresponding to the time shift time.

The time shift amount to bit converter 180 stores, for example, the conversion table shown in FIG. 30, and obtains 2-bit data corresponding to the time shift amount by using the conversion table.

As described above, the first embodiment delimits input data into unit data each having a predetermined bit length, and generates symbols each corresponding to the unit data including the input data by cyclically shifting the samples of the preceding symbol by a time shift amount corresponding to the unit data, thereby providing strong resilience against a multipath propagation path. In addition, the transmitting apparatus generates each transmission symbol by cyclically shifting the samples of the preceding symbol, and the receiving apparatus can perform demodulation from the phase of a reception signal (from a time shift amount corresponding to the preceding symbol) by performing differential coding. This eliminates the necessity to use an equalizer for demodulation. That is, the embodiment can easily perform modulation from the phase of a reception signal (without using the amplitude of the reception signal) even if the transmission rate is high and is affected by multipath interference.

### Second Embodiment

A transmitting apparatus according to the second embodiment will be described.

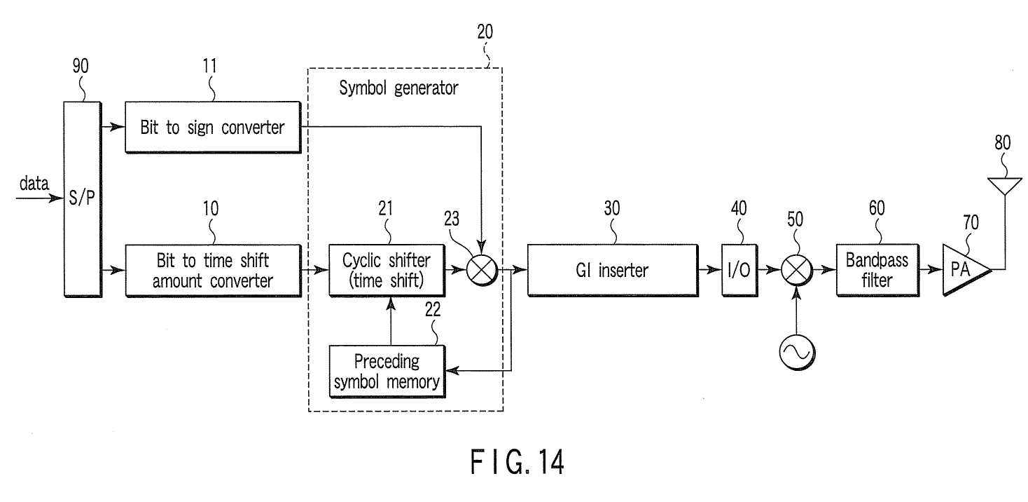

The same reference numerals as in FIG. 14, which shows an example of the arrangement of the transmitting apparatus, denote the same parts in FIG. 1, and differences between them will be mainly described below. The arrangement of this transmitting apparatus differs from that (FIG. 1) of the transmitting apparatus according to the first embodiment in that it additionally includes an SP converter 90, a bit to sign converter 11, and a multiplier 23 located behind a cyclic shifter 21 in a symbol generator 20, as shown in FIG. 14.

The SP converter 90 serial to parallel-converts input serial data into two data sequences. One of the two data sequences is input to the bit to sign converter 11 and the other of the two data sequences is input to a bit to time shift amount converter 10.

The bit to sign converter 11 delimits input data sequence into unit data each having a predetermined first bit length, and converts each unit data into sign by using a conversion table like that shown in FIG. 31. As shown in FIG. 31, when the bit length of unit data is 1, the bit to sign converter 11 outputs the sign “+” if the unit data is “0”, and outputs the sign “−” if the unit data is “1”.

As in the first embodiment described above, the bit to time shift amount converter 10 delimits input data sequence into unit data each having a predetermined second bit length, and converts each unit data into a time shift amount by using a conversion table like that shown in FIG. 29.

The multiplier 23 located behind the cyclic shifter 21 in the symbol generator 20 multiplies the symbol output from the cyclic shifter 21 by the sign output from the bit to sign converter 11.

According to the transmitting apparatus of the second embodiment, the bit length of data to be transmitted with one symbol is a total of three, i.e., two bits which are converted into a time shift amount by the bit to time shift amount converter 10 and one bit which is converted into a sign by the bit to sign converter 11. As compared with the first embodiment described above, the bit length of data to be transmitted with one symbol can be increased by the bit length of data corresponding to a sign by which a symbol is multiplied. This makes it possible to increase the transmission rate.

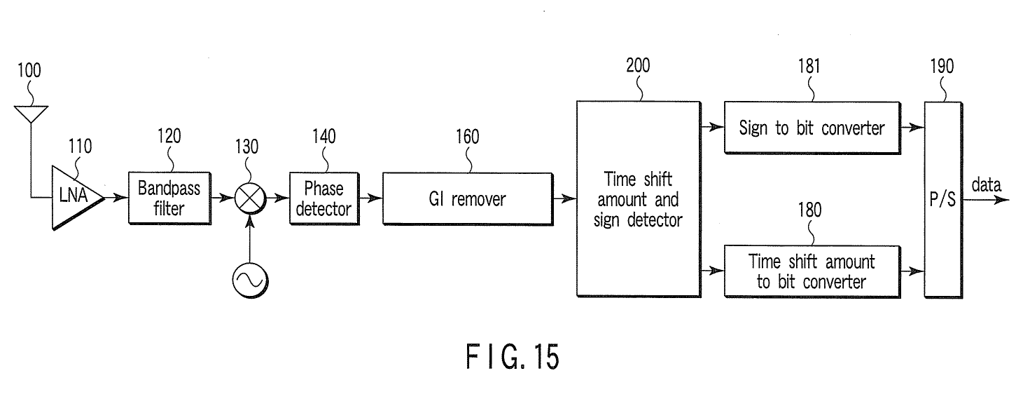

A receiving apparatus shown in FIG. 15 according to the second embodiment will be described next. The same reference numerals as in FIG. 3 denote the same parts in FIG. 15, and differences between them will be mainly described below.

This receiving apparatus differs from the receiving apparatus (FIG. 3) of the first embodiment in that it includes a time shift amount and sign detector 200 in FIG. 15 instead of the time shift amount detector 170 in FIG. 3, and further includes a sign to bit converter 181 and a PS converter 190.

The time shift amount and sign detector 200 shown in FIG. 16 includes a constant output device 202, converter 201, correlation calculator 171, preceding symbol memory 206, absolute value calculator 203, maximum value detector 173, converter 174, maximum value to phase converter 204, and sign detector 205.

In this case, the phase of the nth sample of the Mth symbol is represented by

∠xₙ^{(M)}(0≦n≦N−1)

### Assume that one symbol contains N samples from n=0 to n=N−1.

The operation of the time shift amount and sign detector 200 for the Mth symbol will be described below.

The converter 201 receives digital signals (∠x₀^{(M)}, . . . ,∠x_{N-1}^{(M)}) each representing the phase of each sample in the Mth symbol obtained when a GI remover 160 removes a guard interval.

The converter 201 converts the input digital signals into complex signals (x′₀^{(M)}, . . . ,x′_{N-1}^{(M)}) each having the value output from the constant output device 202 as amplitude. The converter 201 then outputs the complex signals to the correlation calculator 171.

The correlation calculator 171 calculates the correlation value between the above complex signals and the complex signals of the preceding symbol stored in the preceding symbol memory 206. The complex signals of the preceding symbol are represented by (x′₀^{(M-1)}, . . . ,x′_{N-1}^{(M-1)}).

The correlation calculator 171 calculates a correlation value yₙ′ (y₀′, . . . , y_{N-1}′) between the (M−1)th symbol stored in the preceding symbol memory 206 and the Mth symbol, by using following formula (2), while cyclically shifting the (M−1)th symbol by one sample time at a time (in the same direction as the cyclic shift direction in the cyclic shifter 21 of the transmitting apparatus).

$$\begin{matrix}{y}_{n}^{′} = {\sum }_{p = 0}^{N - 1} {x}_{p}^{′ ( M )} {x}_{MOD ( p - n + N , N )}^{′ ( M - 1 ) *} & ( 0 \leq n \leq N - 1 )\end{matrix} \qquad ( 2 )$$

Note that x′ₚ^{(M-1)}* is a complex conjugate of x′ₚ^{(M-1)}, and MOD(a,b) is a value obtained by performing modulus operation of b with respect to a.

In this case, let y₀′ be the correlation value obtained between the (M−1)th symbol and the Mth symbol without cyclically shifting the (M−1)th symbol (when the (M−1)th symbol is cyclically shifted by 0 sample times), y₁′ be the correlation value obtained between the (M−1)th symbol and the Mth symbol when the (M−1)th symbol is cyclically shifted by one sample time, y₂′ be the correlation value obtained between the (M−1)th symbol and the Mth symbol when the (M−1)th symbol is cyclically shifted by two sample times, and y_{N-1}′ be the correlation value obtained between the (M−1)th symbol and the Mth symbol when the (M−1)th symbol is cyclically shifted by (N−1) sample times.

The absolute value calculator 203 obtains the absolute values (|y₀′|, . . . , |y_{N-1}′|) of a plurality of correlation values (y₀′, . . . , y_{N-1}′) obtained while performing cyclic shifting by one sample time at a time.

The maximum value detector 173 detects a value |yₙ′|(0≦n≦N−1), of the absolute values (|y₀′|, . . . , |y_{N-1}′|) obtained by the absolute value calculator 203, which has a highest level, and inputs the maximum correlation value |yₙ′| to the converter 174 and the maximum value to phase converter 204.

As in the first embodiment (see FIG. 13), the converter 174 converts the maximum correlation value |yₙ′| detected by the maximum value detector 173 into a cyclic shift amount (sample time count) up to the maximum correlation value, i.e., “n sample times”.

The maximum value to phase converter 204 detects a phase difference θ between the (M−1)th symbol and the Mth symbol by referring to the correlation value yₙ′ (calculated by the correlation calculator 171) corresponding to the maximum correlation value |yₙ′|.

The sign detector 205 detects the sign “+” if the phase 0 detected by the maximum value to phase converter 204 is defined by

−π/2≦θ<π/2

and detects the sign “−” if the phase θ is defined by

π/2≦θ<3π/2

Referring back to FIG. 15, the sign to bit converter 181 stores, for example, a conversion table like that shown in FIG. 32, and obtains 1-bit data corresponding to the sign detected by the sign detector 205 by using the conversion table.

As in the first embodiment, a time shift amount to bit converter 180 stores the conversion table shown in FIG. 30 in advance, and obtains 2-bit data corresponding to the time shift amount obtained by the converter 174 by using the conversion table.

The PS converter 190 converts both the 1-bit data obtained by the sign to bit converter 181 and the 2-bit data obtained by the time shift amount to bit converter 180 into serial data.

As described above, the transmitting apparatus according to the second embodiment can increase the bit length per symbol, and hence can increase the transmission rate.

### Third Embodiment

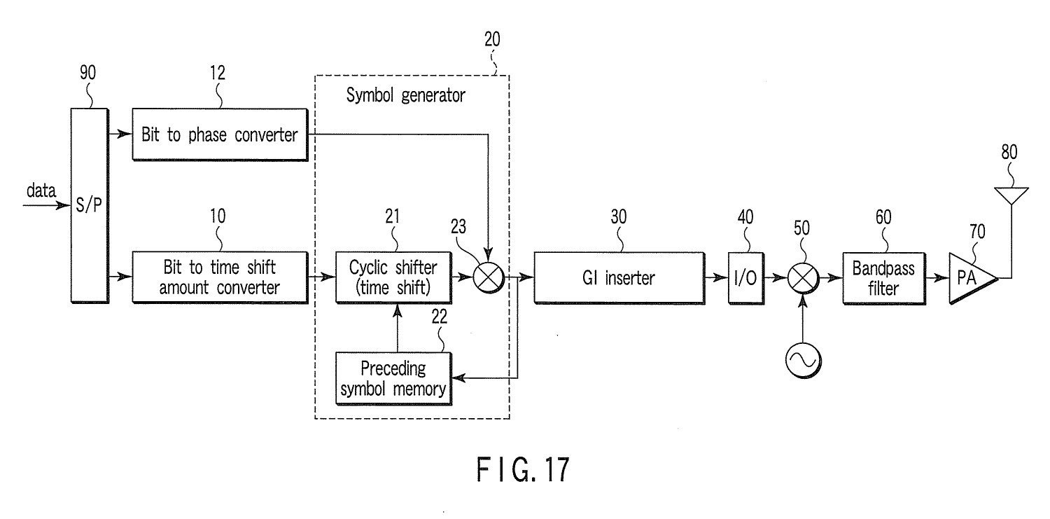

A transmitting apparatus shown in FIG. 17 according to the third embodiment will be described. The same reference numerals as in FIG. 17 denote the same parts in FIG. 1, and differences between them will be mainly described below. This transmitting apparatus differs from the transmitting apparatus (FIG. 1) according to the first embodiment in that it additionally includes an SP converter 90, a bit to phase converter 12, and a multiplier 23 located behind a cyclic shifter 21 in a symbol generator 20 in FIG. 17.

The SP converter 90 serial-to-parallel-converts input data into two data sequences. One of the two data sequences is input to the bit to phase converter 12 and the other of the two data sequences is input to a bit to time shift amount converter 10.

The bit to phase converter 12 delimits input data sequence into unit data each having a predetermined third bit length, and converts each data unit into phase by using a conversion table like that shown in FIG. 33. As shown in FIG. 33, when the bit length of unit data is two bits, the bit to phase converter 12 outputs the phase “0” if the unit data is “00”, outputs the phase “π/2” if the unit data is “01”, outputs the phase “π” if the unit data is “10”, and outputs the phase “3π/2” if the unit data is “11”.

As in the first embodiment described above, the bit to time shift amount converter 10 delimits input data sequence into unit data having a fourth bit length, and converts each unit data into a time shift amount by using a conversion table like that shown in FIG. 29.

The multiplier 23 located behind the cyclic shifter 21 in the symbol generator 20 multiplies the phase output from the bit to phase converter 12 by the symbol output from the cyclic shifter 21.

According to the transmitting apparatus of the third embodiment, the bit length of data to be transmitted with one symbol is a total of four, i.e., two bits which are converted into a time shift amount by the bit to time shift amount converter 10 and two bits which are converted into a phase by the bit to phase converter 12. As compared with the first embodiment described above, this apparatus can increase the bit length of data to be transmitted with one symbol by 2 bits corresponding to a phase by which a symbol is multiplied, and hence can increase the transmission rate.

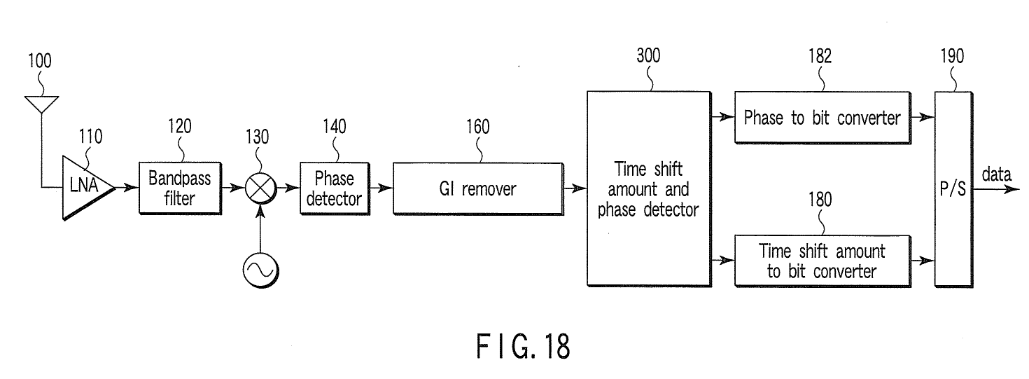

A receiving apparatus shown in FIG. 18 according to the third embodiment will be described next. The same reference numerals as in FIG. 3 denote the same parts in FIG. 18, and differences between them will be mainly described below.

This receiving apparatus differs from the receiving apparatus (FIG. 3) of the first embodiment in that it includes a time shift amount and phase detector 300 instead of the time shift amount detector 170 in FIG. 3, and further includes a phase to bit converter 182 and a PS converter 190, as shown in FIG. 18.

The time shift amount and phase detector 300 receives a digital signal from which a guard interval is removed by a GI remover 160.

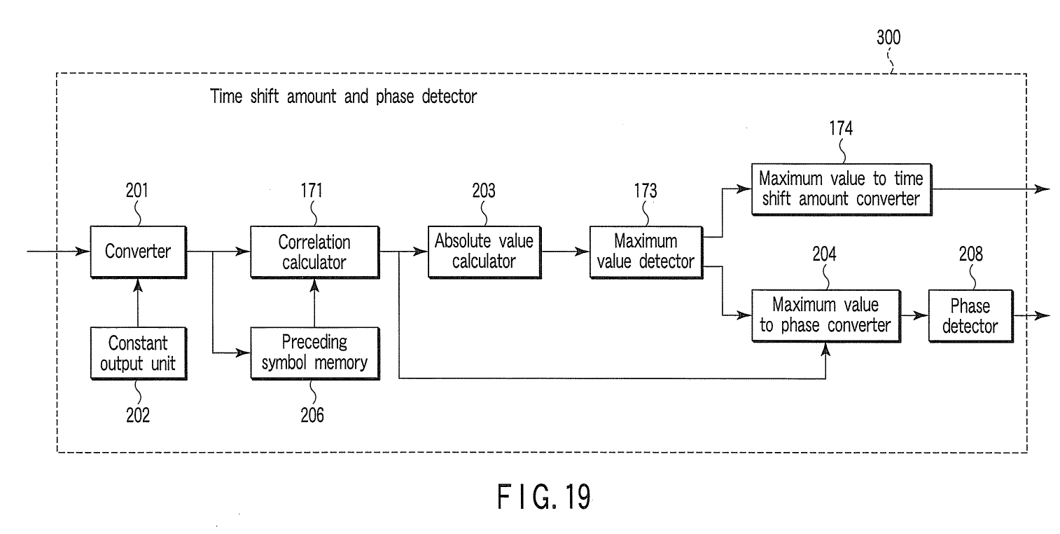

FIG. 19 shows an example of the arrangement of the time shift amount and phase detector 300. The same reference numerals as in FIG. 19 denote the same parts of the arrangement of the time shift amount and sign detector 200 (FIG. 16) of the second embodiment, and differences between them will be mainly described.

The time shift amount and phase detector 300 includes a constant output unit 202, converter 201, correlation calculator 171, preceding symbol memory 206, absolute value calculator 203, maximum value detector 173, converter 174, maximum value to phase converter 204, and phase detector 208.

In this case, the phase of the nth sample of the Mth symbol is represented by

∠xₙ^{(M)}(0≦n≦N−1)

Assume that one symbol contains N samples from n=0 to n=N−1.

The operation of the time shift amount and phase detector 300 will be described below.

The converter 201 receives the digital signals (∠x₀^{(M)}, . . . ,∠x_{N-1}^{(M)}) each representing the phase of each sample in the Mth symbol which is obtained by removing a guard interval using the GI remover 160.

The converter 201 converts the input digital signals into complex signals (x′₀^{(M)}, . . . ,x′_{N-1}^{(M)}) each having the value output from the constant output unit 202 as amplitude.

The converter unit 201 then outputs the complex signals to the correlation calculator 171.

The correlation calculator 171 calculates the correlation value between the above complex signals and complex signals of the preceding symbol stored in the preceding symbol memory 206. The complex signals of the preceding symbol are represented by (x′₀^{(M-1)}, . . . ,x′_{N-1}^{(M-1)}).

The correlation calculator 171 calculates correlation value yₙ′ (y₀′, . . . , y_{N-1}′) between the (M−1)th symbol stored in the preceding symbol memory 206 and the Mth symbol by using following formula (3), while cyclically shifting the (M−1)th symbol by one sample time at a time (in the same direction as the cyclic shift direction in the cyclic shifter 21 of the transmitting apparatus).

$$\begin{matrix}{y}_{n}^{′} = {\sum }_{p = 0}^{N - 1} {x}_{p}^{′ ( M )} {x}_{MOD ( p - n + N , N )}^{′ ( M - 1 ) *} & ( 0 \leq n \leq N - 1 )\end{matrix} \qquad ( 3 )$$

Note that x′ₚ^{(M-1)}* is a complex conjugate of x′ₚ^{(M-1)}, and MOD(a,b) is a value obtained by performing modulus operation of b with respect to a.

In this case, let y₀′ be the correlation value obtained between the (M−1)th symbol and the Mth symbol without cyclically shifting the (M−1)th symbol (when the (M−1)th symbol is cyclically shifted by 0 sample times), y₁′ be the correlation value obtained between the (M−1)th symbol and the Mth symbol when the (M−1)th symbol is cyclically shifted by one sample time, y₂′ be the correlation value obtained between the (M−1)th symbol and the Mth symbol when the (M−1)th symbol is cyclically shifted by two sample times, and y_{N-1}′ be the correlation value obtained between the (M−1)th symbol and the Mth symbol when the (M−1)th symbol is cyclically shifted by (N−1) sample times.

The absolute value calculator 203 obtains the absolute values (|y₀′|, . . . , |y_{N-1}′|) of a plurality of correlation values (y₀′, . . . , y_{N-1}′) obtained while performing cyclic shifting by one sample time at a time.

The maximum value detector 173 detects a value |yₙ′|(0≦n≦N−1), of the absolute values (|y₀′|, . . . , |y_{N-1}′|) obtained by the absolute value calculator 203, which has a highest level, and inputs the maximum correlation value |yₙ′| to the converter 174 and the maximum value to phase converter 204.

As in the first embodiment (see FIG. 13), the converter 174 outputs cyclic shift amounts (sample time counts) until the maximum correlation value |yₙ′| detected by the maximum value detector 173 is obtained, i.e., “n sample times”.

The maximum value to phase converter 204 detects a phase difference θ between the (M−1)th symbol and the Mth symbol by referring to the correlation value yₙ′ (calculated by the correlation calculator 171) corresponding to the maximum correlation value |yₙ′|.

Assume that phases are assigned in the manner shown in FIG. 33 in the bit to phase converter 12 of the transmitting apparatus in FIG. 17. In this case, if the phase θ detected by the maximum value to phase converter 204 is defined by

−π/4≦θ<π/4

the phase detector 208 detects the phase “0”. If the phase θ detected by the maximum value to phase converter 204 is defined by

π/4≦θ<3π/4

the phase detector 208 detects the phase “π/2”.

If the phase θ detected by the maximum value to phase converter 204 is defined by

3π/4≦θ<5π/4

the phase detector 208 detects the phase “π”.

If the phase θ detected by the maximum value to phase converter 204 is defined by

5π/4≦θ<7π/4

the phase detector 208 detects the phase “3π/2”.

Referring back to FIG. 18, the phase to bit converter 182 stores a conversion table like that shown in FIG. 34 in advance, and obtains 2-bit data corresponding to the phase detected by the phase detector 208 by using the conversion table.

In addition, as in the first embodiment, the time shift amount to bit converter 180 stores the conversion table shown in FIG. 30 in advance, and obtains 2-bit data corresponding to the time shift amount obtained by the converter 174 by using the conversion table.

The PS converter 190 converts both the 2-bit data obtained by the phase to bit converter 182 and the 2-bit data obtained by the time shift amount to bit converter 180 into serial bits.

As described above, the transmitting apparatus according to the third embodiment can increase the bit count per symbol, and hence can increase the transmission rate.

### Fourth Embodiment

A receiving apparatus shown in FIG. 20 according to the fourth embodiment will be described. The same reference numerals as in FIG. 3 denote the same parts in FIG. 20 showing an example of the arrangement of the receiving apparatus of the first embodiment, and differences between them will be mainly described below. That is, this receiving apparatus includes a time shift amount detector 400 instead of the time shift amount detector 170 in FIG. 3.

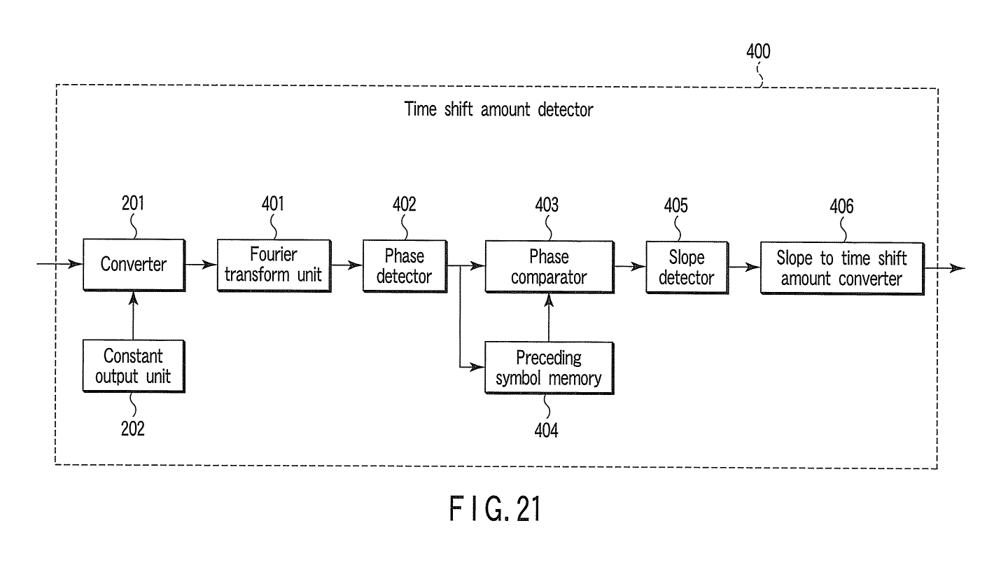

The time shift amount detector 400 shown in FIG. 21 includes a converter 201, constant output unit 202, Fourier transform unit 401, phase detector 402, preceding symbol memory 404, phase comparator 403, slope detector 405, and slope to time shift amount converter 406.

The time shift amount detector 400 detects a time shift amount by using the following Fourier transform characteristics.

Letting s(1) be a time signal with one symbol comprising N (0, 1, . . . , N−1) and S(K) (K=0, 1, . . . , N−1) be the frequency signal of each sample after the Fourier transform of s(1), a frequency signal after the Fourier transform of each sample of a signal s(1−n) obtained as a result of cyclically shifting s(1) by n (0≦n≦N−1) sample times is given by

$$S ( K ) exp ( - j \frac{2 π n K}{N} ) .$$

It is therefore obvious that a cyclic shift component n (0≦n≦N−1) in the time domain appears as a phase rotation amount

$$exp ( - j \frac{2 π n K}{N} )$$

in the frequency domain.

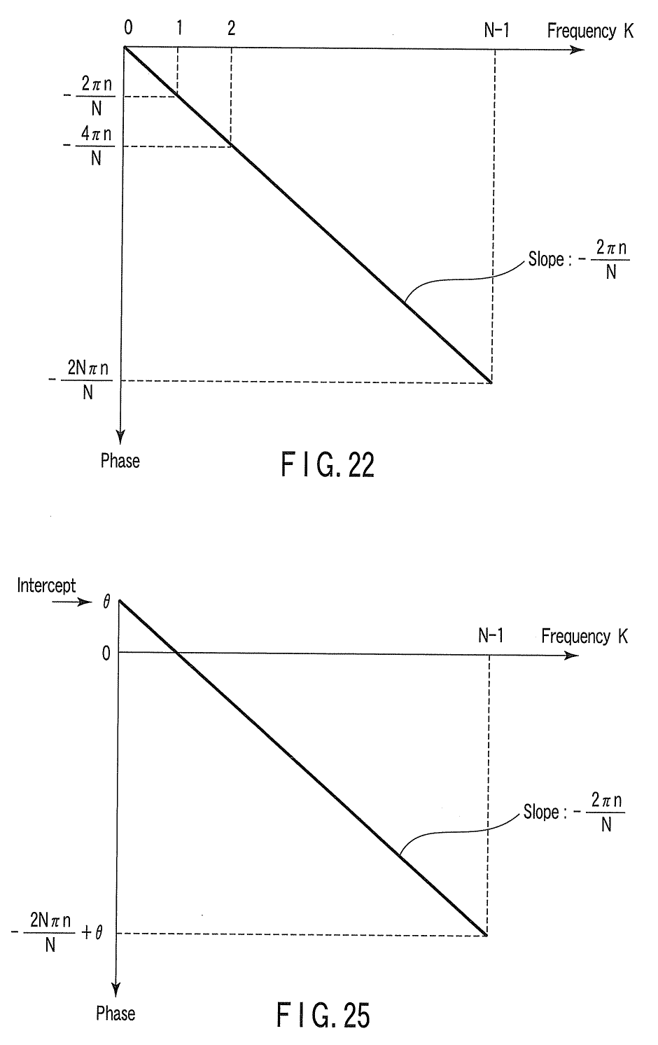

FIG. 22 is a graph showing changes in phase rotation amount as a function of frequency. FIG. 22 shows a straight line representing the phase characteristic of each sample (K=0, 1, . . . , N−1) in a symbol in a frequency domain. As is obvious from FIG. 22, the cyclic shift component n (0≦n≦N−1) in the time domain can be detected from a slope (=−2πn/N) of a phase rotation amount. The time shift amount detector 400 detects a time shift amount by using this characteristic.

In this case, the phase of the nth sample of the Mth symbol is represented by

∠xₙ^{(M)}(0≦n≦N−1)

### Assume that one symbol contains N samples from n=0 to n=N−1.

The operation of the time shift amount detector 400 for the Mth symbol will be described below.

The converter 201 receives digital signals (∠x₀^{(M)}, . . . ,∠x_{N-1}^{(M)}) each representing the phase of each ample in the Mth symbol that is obtained when a GI remover 160 removes a guard interval.

The converter 201 converts the input digital signals into complex signals (x′₀^{(M)}, . . . ,x′_{N-1}^{(M)}) each having the value output from the constant output unit 202 as amplitude.

The converter 201 then outputs the above complex signals each corresponding to each sample to the Fourier transform unit 401.

The Fourier transform unit 401 obtains a frequency signal corresponding to each sample by Fourier transforming the above complex signal. Each frequency signal corresponding to each sample is represented by

(X′₀^{(M)}, . . . ,X′_{N-1}^{(M)})

wherein X′ₙ^{(M)}=|X′ₙ^{(M)}|exp(j∠X′ₙ^{(M)})(0≦n≦N−1).

The phase detector 402 then detects the phase of each sample from the above frequency signal. Each phase corresponding to each sample is represented by (∠X′₀^{(M)}, . . . ,∠X′_{N-1}^{(M)}).

The phase comparator 403 compares (∠X′₀^{(M)}, . . . ,∠X′_{N-1}^{(M)}) which are phases of samples of the Mth symbol and are detected by the phase detector 402 with (∠X′₀^{(M-1)}, . . . ,∠X′_{N-1}^{(M-1)}) which are phases corresponding to samples of the preceding symbol stored in the preceding symbol memory 404, i.e., the (M−1)th symbol. That is to say, The phase comparator 403 performs, for all values n satisfying 0≦n≦N−1, the computation represented by expression (4) given below between (∠X′₀^{(M)}, . . . ,∠X′_{N-1}^{(M)}) corresponding to the Mth symbol and (∠X′₀^{(M-1)}, . . . ,∠X′_{N-1}^{(M-1)}) corresponding to the (M−1)th symbol, to obtain the phase differences ∠θ₀, . . . ,∠θ_{N-1}, each of which are calculated between samples of two consecutive symbols as described by equation (4).

∠θₙ=φx′ₙ^{(M)}−φx′ₙ^{(M-1)}(0≦n≦N−1) (4)

The slope detector 405 approximates the phase differences between two consecutive symbols calculated by the phase comparator 403 to a straight line on a plane with the abscissa representing frequencies and the ordinate representing phase differences, and obtains a slope Δa of the straight line. Note that, for example, a least squares method is available as a method of making approximation to a straight line.

As shown in FIG. 22, since the phase characteristic of each sample (K=0, 1, . . . , N−1) in a symbol in the frequency domain can be represented by a straight line, the phase characteristic of the phase difference between the phase of each sample in the (M−1)th symbol and the phase of each sample in the Mth symbol in the frequency domain can also be represented by a straight line. Using the slope Δa makes it possible to obtain a cyclic shift amount between the two consecutive symbols (i.e., the time shift amount required for the index sample in the (M−1)th symbol to come to the time position of the index sample in the Mth symbol by cyclically shifting the samples of the (M−1)th symbol).

That is, the slope to time shift amount converter 406 performs the computation represented by expression (5) given below by using the slope Δa detected by the slope detector 405 for all the values n satisfying 0≦n≦N−1.

$$\begin{matrix}\vert Δ a - \frac{2 π n}{N} \vert & & ( 0 \leq n < N - 1 )\end{matrix} \qquad ( 5 )$$

The slope to time shift amount converter 406 detects the minimum value n of the values given by equation (5) as a time shift amount.

In this manner, the slope to time shift amount converter 406 detects a cyclic shift amount in the time domain from the slope of a phase rotation amount in the frequency domain. Therefore, when phase values at low frequencies at which the reliability is low are not used or reception is performed by using a plurality of antennas, selecting a phase value with high reliability for each frequency makes it possible to improve the estimation accuracy for a time shift.

### Fifth Embodiment

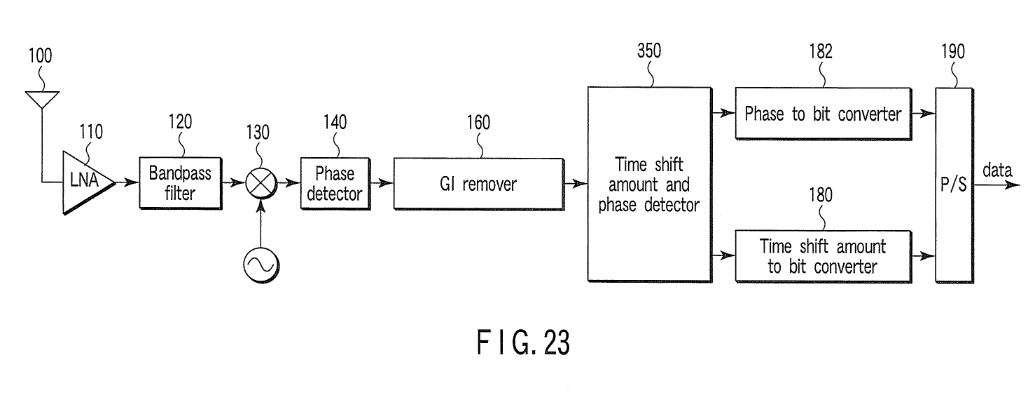

A receiving apparatus shown in FIG. 23 according to the fifth embodiment will be described.

The same reference numerals as in FIG. 18 denote the same parts in FIG. 23 showing an example of the arrangement of the receiving apparatus of the third embodiment, and differences between them will be mainly described below. That is, the arrangement in FIG. 23 includes a time shift amount and phase detector 350 instead of the time shift amount and phase detector 300 in FIG. 18.

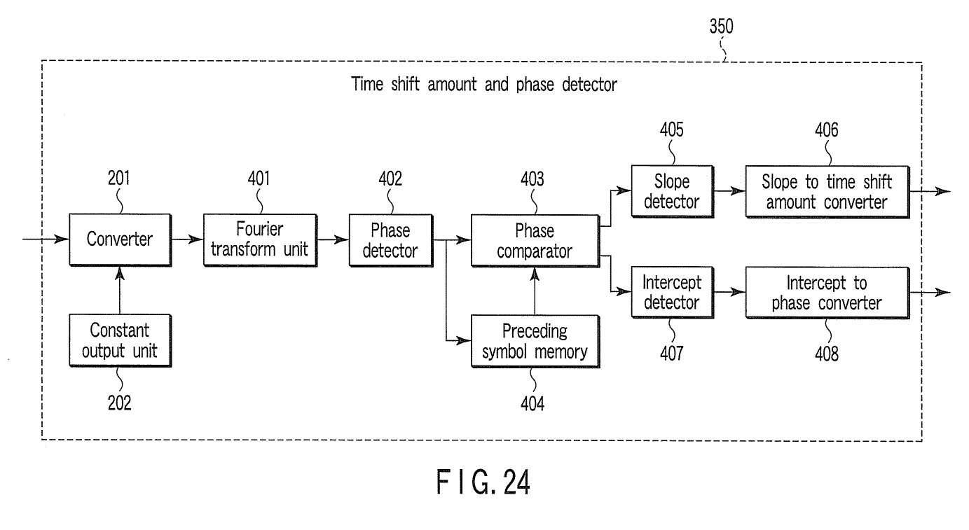

The time shift amount and phase detector 350 shown in FIG. 24 includes a converter 201, constant output unit 202, Fourier transform unit 401, phase detector 402, preceding symbol memory 404, phase comparator 403, slope detector 405, slope to time shift amount converter 406, intercept detector 407, and intercept to phase converter 408.

The time shift amount and phase detector 350 detects a time shift amount and a phase by using the following Fourier transform characteristics.

Letting s(1) be a time signal with one symbol comprising N (0, 1, . . . , N−1) and S(K) (K=0, 1, . . . , N−1) be the frequency signal of each sample after the Fourier transform of s(1), a frequency signal after the Fourier transform of each sample of a signal s(1−n)exp(jθ) obtained by cyclically shifting s(1) by n (0≦n≦N−1) sample times is given by

$$S ( K ) exp [ j ( - \frac{2 π n K}{N} + θ ) ] .$$

It is therefore obvious that a cyclic shift component n (0≦n≦N−1) in the time domain appears as a phase rotation amount

$$exp [ j ( - \frac{2 π n K}{N} + θ ) ]$$

in the frequency domain.

FIG. 25 is a graph showing changes in phase rotation amount as a function of frequency. FIG. 25 shows a straight line representing the phase characteristic of each sample (K=0, 1, . . . , N−1) in a symbol in the frequency domain. As is obvious from FIG. 25, the cyclic shift component n (0≦n≦N−1) in the time domain can be detected from a slope (=−2πn/N) of a phase rotation amount, and the phase θ can be detected from a intercept. The time shift amount and phase detector 350 detects a time shift amount and a phase by using these characteristics.

In this case, the phase of the nth sample of the Mth symbol is represented by

∠xₙ^{(M)}(0≦n≦N−1).

Assume that one symbol contains N samples from n=0 to n=N−1.

The operation of the time shift amount and phase detector 350 for the Mth symbol will be described below.

The converter 201 receives the following signal representing the phase of each sample in the Mth symbol which is obtained by removing a guard interval using a GI remover 160.

(∠x₀^{(M)}, . . . ,∠x_{N-1}^{(M)})

The converter 201 converts the input signal into following complex signal having the value output from the constant output unit 202 as an amplitude.

(x′₀^{(M)}, . . . ,x′_{N-1}^{(M)})

The converter 201 then outputs the above complex signal to the Fourier transform unit 401.

The Fourier transform unit 401 transforms the above complex signal into following frequency signal.

(X′₀^{(M)}, . . . ,X′_{N-1}^{(M)})

The phase detector 402 then detects the following phase of each sample from the frequency signal.

(∠X′₀^{(M)}, . . . ,∠X′_{N-1}^{(M)})

The phase comparator 403 compares (∠X′₀^{(M)}, . . . ,∠X′_{N-1}^{(M)}) which are phases of samples of the Mth symbol and are detected by the phase detector 402 with (∠X′₀^{(M-1)}, . . . ,∠X′_{N-1}^{(M-1)}) which are phases corresponding to samples of the preceding symbol stored in the preceding symbol memory 404, i.e., the (M−1)th symbol. That is to say, The phase comparator 403 performs, for all values n satisfying 0≦n≦N−1, the computation represented by expression (6) given below between (∠X′₀^{(M)}, . . . ,∠X′_{N-1}^{(M)}) corresponding to the Mth symbol and (∠X′₀^{(M-1)}, . . . ,∠X′_{N-1}^{(M-1)}) corresponding to the (M−1)th symbol, to obtain the phase differences ∠θ₀, . . . ,∠θ_{N-1}, each of which are calculated between samples of two consecutive symbols as described by equation (6).

φθₙ=φx′ₙ^{(M)}−φx′ₙ^{(M-1)}(0≦n≦N−1) (6)

The slope detector 405 and the intercept detector 407 receive the phase differences (∠θ₀, . . . ,∠θ_{N-1}) between the respective samples of the two consecutive symbols which are calculated by the phase detector 402.

As in the fourth embodiment, the slope detector 405 approximates the phase differences between the respective samples of the two consecutive symbols, which are calculated by the phase comparator 403, to a straight line on a plane with the abscissa representing frequencies and the ordinate representing phase differences by using a least squares method, and obtains a slope Δa of the straight line.

The slope to time shift amount converter 406 then detects the minimum value n of the values given by expression (5) as a time shift amount.

The intercept detector 407 approximates the phase differences between the respective samples of the two consecutive symbols, which are calculated by the phase comparator 403, to a straight line on a plane with the abscissa representing frequencies and the ordinate representing phase differences, and obtains a intercept Δb. Note that, for example, a least squares method is available as a method of making approximation to a straight line.

Assume that phases are assigned in the manner shown in FIG. 33 in the bit to phase converter 12 of the transmitting apparatus. In this case, if the intercept Δb detected by the intercept detector 407 is given by

−π/4≦Δb<π/4

the intercept to phase converter 408 outputs the phase “0”. If the intercept Δb detected by the intercept detector 407 is given by

π/4≦Δb<3π/4

the intercept to phase converter 408 outputs the phase “π/2”. If the intercept Δb detected by the intercept detector unit 407 is given by

3π/4≦Δb<5π/4

the intercept to phase converter 408 outputs the phase “π”. If the intercept Δb detected by the intercept detector 407 is given by

5π/4≦Δb<7π/4

the intercept to phase converter 408 outputs the phase “3π/2”.

As described in the second embodiment, even if the transmitting apparatus multiplies a sign instead of a phase, the apparatus can detect the sign by the same processing as that described above. Time shift amount detection is the same as that in the fourth embodiment.

### Sixth Embodiment

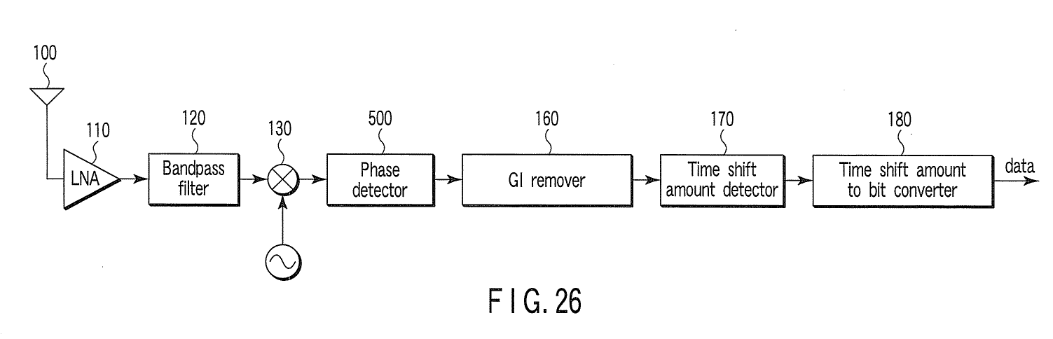

A receiving apparatus shown in FIG. 26 according to the sixth embodiment will be described.

The same reference numerals as in FIG. 3 denote the same parts in FIG. 26 showing an example of the arrangement of the receiving apparatus of the first embodiment, and differences between them will be mainly described below. That is, this receiving apparatus includes a phase detector 500 instead of the phase detector 140 in FIG. 3.

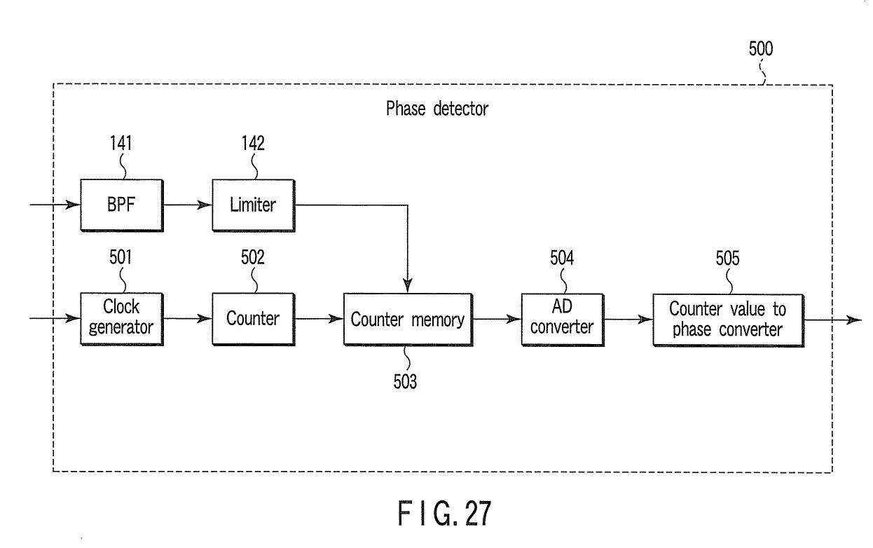

The phase detector 500 shown in FIG. 27 includes a band pass filter (BPF) 141, limiter 142, clock generator 501, counter 502, counter memory 503, AD converter 504, and counter value to phase converter 505.

The phase detector 500 detects the relative phase difference between the rectangular wave output from the limiter 142 and the clock signal generated by the clock generator 501.

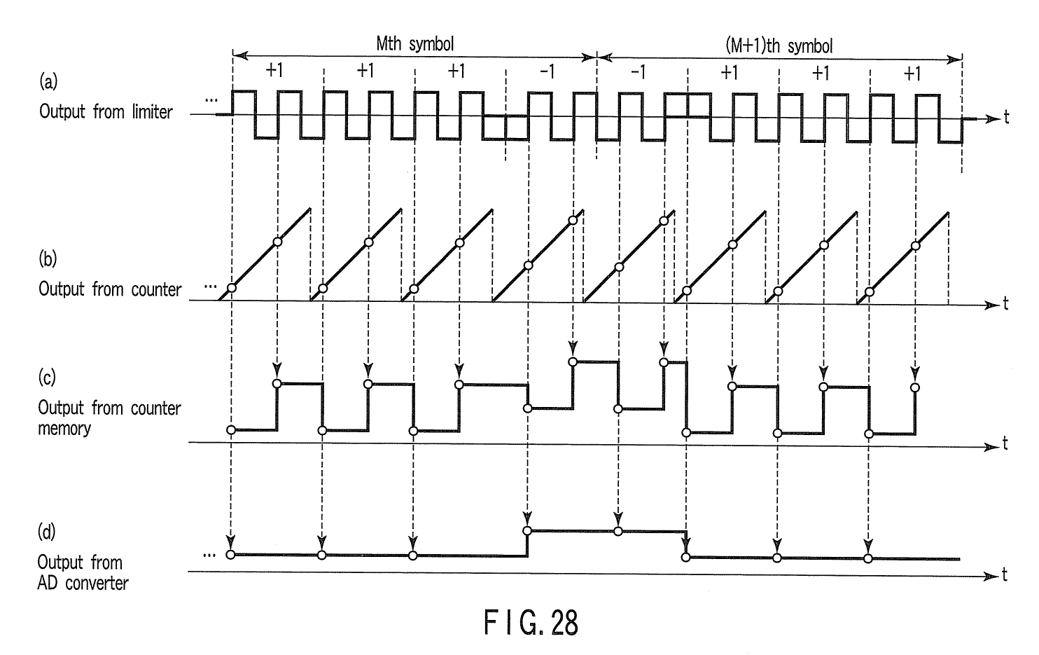

FIG. 28 is timing chart for explaining the operation of the phase detector 500.

An LNA 110 amplifies the RF signal received by an antenna 100. A bandpass filter 120 then band-limits this signal. A frequency converter 130 converts the signal band-limited by the bandpass filter 120 into an IF signal and inputs it to the phase detector 500.

In the phase detector 500, first of all, the bandpass filter 141 band-limits the input signal. The limiter 142 then converts the signal into a rectangular wave. In parallel with this operation, the counter 502 receives the clock signal output from the clock generator 501, and counts the number of pulses by adding “1” every time the clock signal rises.

Note that, as shown in FIG. 28, the counter 502 operates in synchronism with the sample frequency of a symbol and repeatedly counts the number of pulses within a predetermined numerical range. That is, the counter 502 is cleared when a predetermined maximum value of counted pulses has been reached, and starts counting the number of pulses from zero again.

The counter memory 503 stores the count value counted by the counter 502, and outputs a counter value at a leading edge (or a trailing edge) of the rectangular wave converted by the limiter 142. FIG. 28 shows a case wherein the counter memory 503 outputs a counter value at a leading edge of the rectangular wave output from the limiter 142.

While samples with the same value continue (for example, the samples “+1” continue in the case shown in FIG. 28), since the leading edges of the rectangular wave appear at equal intervals, the counter memory 503 outputs the same counter value, as shown in FIG. 28(b) and FIG. 28(c). However, in an interval in which different sample values appear (for example, in an interval in which the index samples “−1” appear in the case shown in FIG. 28), since the leading edges of the rectangular wave appear at different timings, the counter memory 503 outputs different counter values, as shown in FIG. 28(c). For example, as the timing of a leading edge retards, the number of pulses counted during this period increases, and vice versa.

The difference between counter values output from the counter memory 503 represents the difference between the phases of the respective samples in a symbol. That is, samples with almost the same counter value have the same phase, and samples which greatly change in counter value indicate a corresponding change in phase. Therefore, the counter values output from the counter memory 503 represent the phases of the respective samples. In addition, using the counter value output from the counter memory 503 makes it possible to detect the time position of an index sample (a sample with the sample value “−1”) which greatly differs in phase (almost “π/2” in FIG. 28) from the remaining samples in a symbol.

The AD converter 504 converts the counter value output from the counter memory 503 into a digital signal. For example, as shown in FIG. 28(d), in the interval in which the counter value remains almost the same, the corresponding digital signal has a constant value. However, in the interval in which the counter value greatly changes (an index sample interval), the corresponding digital signal appears as a value different from the constant value. The counter value to phase converter 505 receives the digital signal output from the AD converter 504.

The counter value to phase converter 505 stores in advance a conversion table for converting a counter value (the value of a digital signal in this case) into a phase, and outputs a phase value corresponding to the value of a digital signal.

Performing phase detection by using a counter in this manner makes it possible to perform phase detection in a digital circuit.

As has been described above, the first to sixth embodiments can perform demodulation with high accuracy by using the phase of a reception signal. That is, using a symbol obtained by cyclically shifting the preceding symbol as the current symbol makes it possible to hold a time shift amount for the preceding symbol even under a multipath environment. This makes it possible to detect a time shift amount for the preceding symbol from the phase of a reception signal and demodulate the signal without using any equalizer.

According to the embodiments described above, a high-speed wireless communication system (a transmitting apparatus and a receiving apparatus) which can perform demodulation with high accuracy using a phase without using the amplitude of a reception signal even under a multipath delay environment can be provided.

The techniques of the present invention which have been described in the embodiments can also be distributed, as programs which can be executed by a computer, by being stored in recording media such as magnetic disks (flexible disks, hard disks, and the like), optical disks (CD-ROMs, DVDs, and the like), and semiconductor memories.

What is claimed is:

1. A transmitting apparatus comprising:
a converter to convert a unit data item having a predetermined bit length into a time shift amount;
a memory to store a first symbol including a plurality of samples;
a symbol generator to generate a second symbol by cyclically shifting the samples in the first symbol by the time shift amount; and
a transmitter to transmit the second symbol.

2. A transmitting apparatus comprising:
a first converter to convert input data into two data sequences, one of the two data sequences including a first unit data item having a first bit length, and the other of the two data sequences including a second unit data item having a second bit length;
a second converter to convert the first unit data item into a time shift amount;
a third converter to convert the second unit data item into a sign which indicates positive or negative;
a memory to store a first symbol including a plurality of samples;
a first generator to generate a second symbol by cyclically shifting the samples in the first symbol by the time shift amount;
a second generator to generate a third symbol by multiplying the second symbol by the sign; and
a transmitter to transmit the third symbol.

3. A transmitting apparatus comprising:
a first converter to convert input data into two data sequences, one of the two data sequences including a first unit data item having a first bit length, and the other of the two data sequences including a second unit data item having a second bit length;
a second converter to convert the first unit data item into a time shift amount;
a third converter to convert the second unit data item into a phase;
a memory to store a first symbol including a plurality of samples;
a first generator to generate a second symbol by cyclically shifting the samples in the first symbol by the time shift amount;
s second generator to generate a third symbol by multiplying the second symbol by the phase; and
a transmitter to transmit the third symbol.

4. A receiving apparatus comprising:
a receiver to receive two consecutive symbols each including a plurality of samples;
a first detector to detect sample values of the samples in each of the symbols;
a second detector to detect a time shift amount between the symbols by comparing the sample values of one of the symbols and the sample values of the other of the symbols; and
a first converter to convert the time shift amount into a first data item having a first bit length.

5. The apparatus according to claim 4, wherein the first detector detects phase of each of the samples as a sample value of each of the samples.

6. The apparatus according to claim 5, further comprising a clock generator to generate a clock signal which synchronizes with a frequency of the symbols; and
wherein the first detector detects the phase relative to the clock signal.

7. The apparatus according to claim 5, wherein the second detector includes
a cyclic shifter to shift the samples in the former of the symbols by zero or one sample time at a time, to obtain a plurality of time shifted symbols corresponding to different time shift amounts,
a calculator to calculate a correlation value between each time shifted symbol and the latter of the symbols by using the phase of each sample in each time shifted symbol and the latter of the symbols, to obtain a plurality of correlation values corresponding to the time shifted symbols, and
a time shift detector to detect one of the time shift amounts corresponds to one of the time shifted symbols whose correlation value is a maximum value of the correlation values.

8. The apparatus according to claim 5, further comprising a clock generator to generate a clock signal which synchronizes with a frequency of the symbols; and
wherein the first detector includes, a generator to generate a phase shifted symbol from a symbol of the symbols, phase difference between the phase shifted symbol and the symbol being 90°, and a detector to detect the phase relative to the clock signal by using the symbol and the phase shifted symbol.

9. The apparatus according to claim 5, wherein the second detector includes
a generator to generate a complex signal corresponding to each sample in each of the symbols by using the phase of each sample,
a cyclic shifter to shift the samples in one of the symbols by zero or one sample time at a time, to obtain a plurality of time shifted symbols corresponding to different time shift amounts,
a calculator to calculate a correlation value between each time shifted symbol and the other of the symbols by using the complex signal of each sample in each time shifted symbol and the other of the symbols, and calculate an absolute value of the correlation value, to obtain a plurality of correlation values and absolute values corresponding to the time shifted symbols,
a time shift amount detector to detect one of the time shift amounts corresponds to one of the time shifted symbols whose absolute value is a maximum value of the absolute values, and
a phase difference detector to detect a phase difference between the symbols from one of the correlation values whose absolute value is the maximum value; and further comprising:
a second converter to convert the phase difference into a second data item having a second bit length.

10. The apparatus according to claim 9, wherein the phase difference detector detects a sign corresponding to the phase difference, the sign indicating positive or negative, and the second converter converts the sign into the second data item.

11. The apparatus according to claim 5, wherein the second detector includes
a generator to generate a complex signal corresponding to each sample in each of the symbols by using the phase of each sample,
a phase detector to detect a phase of each sample in each of the symbols by performing Fourier transform on the complex signal corresponding to each sample, and
a time shift amount detector to detect the time shift amount in a time domain from a slope of a straight line representing a phase characteristic of a phase difference between the phase of each sample in a preceding symbol of the symbols and the phase of each sample in a succeeding symbol of the symbols in a frequency domain.

12. The apparatus according to claim 11, wherein the second detector further includes
a phase difference detector to detect a phase difference between the two symbols from a intercept of the straight line; and further comprising:
a second converter to convert the phase difference into a second data item having a second bit length.

13. The apparatus according to claim 5, wherein the first detector includes
a generator to generate a clock signal having a frequency higher than a frequency of the symbols,
a counter to repeatedly count pulses of the clock signal within a predetermined value range, and
a detector to detect the phase of each sample on the basis of a value of the counter at a leading edge of each sample.

14. A transmitting method comprising:
converting a unit data item having a predetermined bit length into a time shift amount;
storing, in a memory, a first symbol including a plurality of samples;
generating a second symbol by cyclically shifting the samples in the first symbol by the time shift amount; and
transmitting the second symbol.

15. A transmitting method comprising:
converting input data into two data sequences, one of the two data sequences including a first unit data item having a first bit length, and the other of the two data sequences including a second unit data item having a second bit length;
converting the first unit data item into a time shift amount;
converting the second unit data item into a sign which indicates positive or negative;
storing, in a memory, a first symbol including a plurality of samples;
generating a second symbol by cyclically shifting the samples in the first symbol by the time shift amount;
generating a third symbol by multiplying the second symbol by the sign; and
transmitting the third symbol.

16. A transmitting method comprising:
converting input data into two data sequences, one of the two data sequences including a first unit data item having a first bit length, and the other of the two data sequences including a second unit data item having a second bit length;
converting the first unit data item into a time shift amount;
converting the second unit data item into a phase;
storing, in a memory, a first symbol including a plurality of samples;
generating a second symbol by cyclically shifting the samples in the first symbol by the time shift amount;
generating a third symbol by multiplying the second symbol by the phase; and
transmitting the third symbol.

17. A receiving method comprising:
receiving two consecutive symbols each including a plurality of samples;
detecting sample values of the samples in each of the symbols;
detecting a time shift amount between the symbols based on the sample values of the samples in each of the symbols; and
converting the time shift amount into a data item having a bit length.

18. The method according to claim 17, wherein each of the sample values is a phase of each sample.
